(19) United States
(12) Patent Application Publication
(10) Pub. No.: US 2025/0321446 A1
(43) Pub. Date: Oct. 16, 2025

(54) DISPLAY PANEL

(71) Applicant: Sharp Display Technology Corporation, Kameyama City (JP)

(72) Inventors: Atsushi KOUMURA, Kameyama City (JP); Shintaro YAMADA, Kameyama City (JP)

(21) Appl. No.: 19/092,109

(22) Filed: Mar. 27, 2025

(30) Foreign Application Priority Data
Apr. 11, 2024 (JP) 2024-064026

(51) Int. Cl. G02F 1/1335; G02F 1/13363

(52) U.S. Cl. CPC G02F 1/133531; G02F 1/13363

(57) ABSTRACT

Provided is a display panel that is less warped in high temperature environments. The display panel includes, in order, a first polarizing plate with a first transmission axis, a first adhesive layer, a display cell, a second adhesive layer, and a second polarizing plate including no phase difference film and with a second transmission axis perpendicular to the first transmission axis. The second adhesive layer has a storage modulus G′ of 40 KPa or lower at 85° C. or higher and 95° C. or lower. The second adhesive layer preferably has a storage modulus G′ of 5 KPa or higher and 40 KPa or lower at 85° C. or higher and 95° C. or lower.

### CROSS-REFERENCE TO RELATED APPLICATIONS

The present application claims priority under 35 U.S.C. § 119 to Japanese Patent Application No. 2024-064026 filed on Apr. 11, 2024, the contents of which are incorporated herein by reference in their entirety.

### BACKGROUND OF THE INVENTION

### Field of the Invention

The following disclosure relates to display panels.

### Description of Related Art

Display panels such as liquid crystal panels have been widely used for televisions, mobile phones, PC displays, and other various devices. Typical display panels have a structure in which optical films such as polarizing plates are bonded to a display cell. For example, liquid crystal panels have a structure in which a liquid crystal cell is held between a pair of polarizing plates. JP 2011-90251 A, JP 2006-18245 A, JP 2007-041116 A, JP 2006-316181 A, and WO 2017/212960 each disclose a technique relating to a display panel.

### BRIEF SUMMARY OF THE INVENTION

JP 2011-90251 A, JP 2006-18245 A, JP 2007-041116 A, JP 2006-316181 A, and WO 2017/212960 each disclose a technique used to reduce warping of a display panel, of which the effects are still insufficient.

In response to the above issues, an object of the present invention is to provide a display panel that is less warped in high temperature environments.

(1) One embodiment of the present invention is directed to a display panel including, in order, a first polarizing plate with a first transmission axis, a first adhesive layer, a display cell, a second adhesive layer, and a second polarizing plate including no phase difference film and with a second transmission axis perpendicular to the first transmission axis, the second adhesive layer having a storage modulus G′ of 40 KPa or lower at 85° C. or higher and 95° C. or lower.

(2) In an embodiment of the present invention, the display panel includes the structure (1), and the second adhesive layer has a storage modulus G′ of 5 KPa or higher and 40 KPa or lower at 85° C. or higher and 95° C. or lower.

(3) In an embodiment of the present invention, the display panel includes the structure (1) or (2), the second adhesive layer after aging of the display panel with a temperature difference ΔT (° C.) has, at 85° C. or higher and 95° C. or lower, a storage modulus G′ that satisfies the following Inequality (1-1):

$$- 0.30 \leq σ ( {G}^{′} ) - ( - 5.0000 \times 1 {0}^{- 4} \times {G}^{′2} + 2.93 \times 1 {0}^{- 2} \times {G}^{′} + 0.7794 ) \leq 0.3 \qquad ( Inequality 1 - 1 )$$

where a σ(G′) is represented by the following Equation (2):

$$σ ( {G}^{′} ) = C 1 \times 1.8315 \times 1 {0}^{- 3} \times {G}^{′} + 0.26666 \qquad ( Equation 2 )$$

where C1 is represented by the following Equation (3):

$$C 1 = \frac{3 {L}^{2} {E}_{1} {E}_{2} {t}_{1} {t}_{2} \times ( {t}_{1} + {t}_{2} ) \times ( {α}_{1} - {α}_{2} ) \times Δ T}{{E}_{1}^{2} {t}_{1}^{4} + 4 {E}_{1} {E}_{2} {t}_{1}^{3} {t}_{2} + 6 {E}_{1} {E}_{2} {C}_{1}^{2} {t}_{2}^{2} + 4 {E}_{1} {E}_{2} {C}_{1} {f}_{2}^{3} + {E}_{2}^{2} {t}_{2}^{4}} \qquad ( Equation 3 )$$

where
L represents a length (mm) that is a half of an absorption axis of the second polarizing plate,
E₁ represents a Young's modulus (GPa) of the second polarizing plate,
E₂ represents a Young's modulus (GPa) of the display cell,
t₁ represents a thickness (mm) of the second polarizing plate,
t₂ represents a thickness (mm) of the display cell,
α₁ represents a coefficient of linear expansion (10⁻⁶/° C.) of the second polarizing plate,
α₂ represents a coefficient of linear expansion (10⁻⁶/° C.) of the display cell, and
ΔT represents a temperature difference (° C.) of the display panel between before and after the aging.

(4) In an embodiment of the present invention, the display panel includes the structure (1), (2), or (3), and the first polarizing plate includes a phase difference film.

(5) In an embodiment of the present invention, the display panel includes the structure (1), (2), (3), or (4), and the first adhesive layer has a storage modulus of 80 KPa or higher at 85° C. or higher and 95° C. or lower.

(6) In an embodiment of the present invention, the display panel includes the structure (1), (2), (3), (4), or (5), and the phase difference film has at least one of an in-plane phase difference or an absolute value of a thickness direction phase difference of 10 nm or more.

The present invention can provide a display panel that is less warped in high temperature environments.

### BRIEF DESCRIPTION OF THE DRAWINGS

FIG. 1 is a schematic perspective view of a display panel according to an embodiment.

FIG. 2 is an enlarged schematic cross-sectional view of the display panel according to the embodiment.

FIG. 3 is a schematic perspective view of a test panel corresponding to the display panel according to the embodiment.

FIG. 4 is an enlarged schematic cross-sectional view of a display panel according to a modified example of the embodiment.

FIG. 5 is a schematic cross-sectional view of a bimetal.

FIG. 6 is a graph of the amount of warping of a panel versus storage modulus G′ of the second adhesive layer.

FIG. 7 is a graph of the measured amount of warping of a strip-sized panel portion versus storage modulus G′ of the second adhesive layer.

FIG. 8 is a graph of the measured amount of warping of a strip-sized panel portion.

FIG. 9 is a graph of the average amount of warping of a standard-sized panel versus storage modulus G′ of the second adhesive layer placed on the back side.

FIG. 10 is a graph of differences between the measured data on the amount of warping of standard panel and σ(G′).

### DETAILED DESCRIPTION OF THE INVENTION

### Definition of Terms

Herein, the “observation surface side” means the side closer to the screen (display surface) of the image display device, and the “back surface side” means the side farther from the screen (display surface) of the image display device.

The storage modulus is a value determined in conformity with JIS K7244-10 (2005) with a rotational rheometer.

Being “parallel” means that the angle (absolute value) formed between two objects falls within a range of 0°±10°, preferably a range of 0°±5°, more preferably a range of 0°±3°, still more preferably a range of 0°±1°, and is particularly preferably 0° (perfectly parallel).

Being “perpendicular” means that the angle (absolute value) formed between two objects falls within a range of 90°±10°, preferably a range of 90°±5°, more preferably a range of 90°±3°, still more preferably a range of 90°±1°, and is particularly preferably 90° (perfectly perpendicular).

The term “(meth)acrylic” collectively refers to acrylic and methacrylic. Thus, for example, a “(meth)acrylic acid ester” collectively refers to an acrylic acid ester and a methacrylic acid ester. The same applies to any other compound denoted with “(meth)”.

Hereinbelow, a display panel according to an embodiment of the present invention is described. The present invention is not limited to the contents described in the following embodiment and can be modified as appropriate within the range that satisfies the configuration of the present invention. A display panel is also referred hereinbelow to as simply “a panel”.

### Embodiment

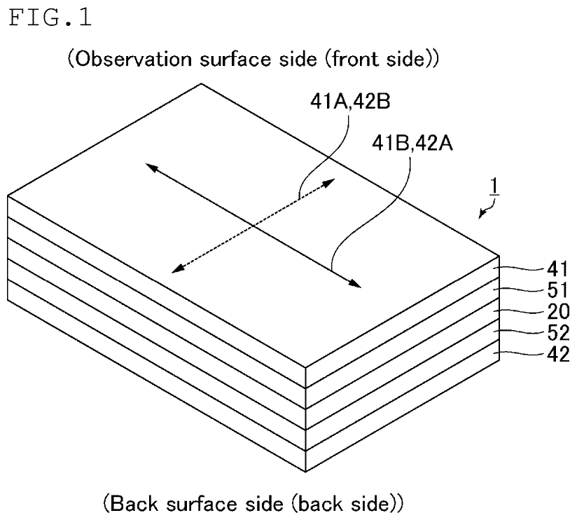

FIG. 1 is a schematic perspective view of a display panel according to an embodiment. As shown in FIG. 1, a display panel 1 according to the present embodiment includes, in order, a first polarizing plate (front polarizing plate) 41 with a first transmission axis 41A, a first adhesive layer (front adhesive layer) 51, a display cell 20, a second adhesive layer (back adhesive layer) 52, and a second polarizing plate (back polarizing plate) 42 including no phase difference film and with a second transmission axis 42A perpendicular to the first transmission axis 41A. The first polarizing plate 41 is disposed on the observation surface side of the display cell 20 via the first adhesive layer 51. The second polarizing plate 42 is disposed on the back surface side of the display cell 20 via the second adhesive layer 52.

The second adhesive layer 52 has a storage modulus G′ of 40 Kpa or lower at 85° C. or higher and 95° C. or lower. This mode can reduce warping of the display panel 1 in high temperature environments. The amount of warping of a display panel in high temperature environments is also referred hereinbelow to as simply “the amount of warping of a panel” or “the amount of warping”. Here, the expression that the storage modulus G′ falls within a certain value range in a certain temperature range means that the storage modulus G′ falls within the certain value range at one or more temperatures within the certain temperature range, and preferably means that the storage modulus G′ falls within the certain value range at all the temperatures within the certain temperature range.

A typical front adhesive layer used to bond a display cell and a front polarizing plate together and a typical back adhesive layer used to bond a display cell and a back polarizing plate together each have a storage modulus of about 80 KPa (or higher) at 85° C. or higher and 95° C. or lower. An adhesive layer having a storage modulus of lower than 80 KPa at 85° C. or higher and 95° C. or lower, if used to bond a polarizing plate and a display cell together, may possibly shift the polarizing plate from the designated bonding position. Thus, to prevent bonding misalignment of a display cell and a polarizing plate, a typical front adhesive layer and a typical back adhesive layer are both set to have a storage modulus of about 80 KPa (or higher).

In contrast, the second adhesive layer 52 according to the present embodiment has a storage modulus of 40 KPa or lower at 85° C. or higher and 95° C. or lower, and thus differs in storage modulus from typical adhesive layers used to bond a display cell and a polarizing plate together.

The following describes the details of the display panel 1 according to the present embodiment.

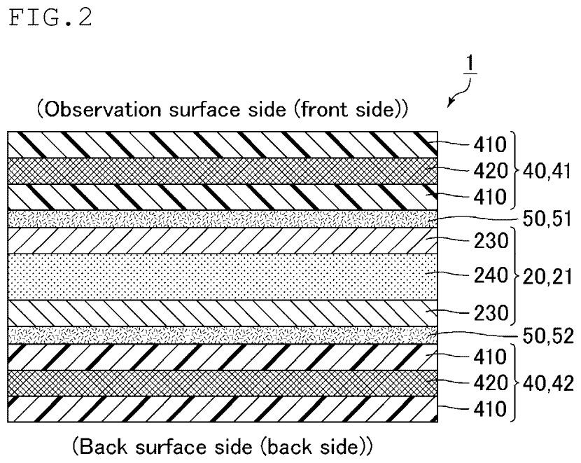

FIG. 2 is an enlarged schematic cross-sectional view of the display panel according to the embodiment. The first polarizing plate 41 and the second polarizing plate 42 may also be collectively referred to as “polarizing plate 40”.

The first polarizing plate 41 has a first transmission axis 41A and a first absorption axis 41B perpendicular to the first transmission axis 41A. The second polarizing plate 42 has a second transmission axis 42A and a second absorption axis 42B perpendicular to the second transmission axis 42A. The first transmission axis 41A is perpendicular to the second transmission axis 42A.

The second polarizing plate 42 includes no phase difference film. The expression that the second polarizing plate 42 includes no phase difference film means not only that the second polarizing plate 42 does not include any phase difference film as its component but also that no phase difference film is attached to the second polarizing plate 42 directly or indirectly via any other component, on a side of the second adhesive layer 52 opposite to the display cell 20. In other words, the expression means that when all the components on the side of the second adhesive layer 52 opposite to the display cell 20 are regarded as the components of the second polarizing plate 42, the second polarizing plate 42 does not include any phase difference film.

The phase difference film means a film that has at least one of an in-plane phase difference or an absolute value of a thickness direction phase difference of 10 nm or more, preferably 20 nm or more.

The in-plane phase difference (Re) means the in-plane phase difference of a layer (film) at 23° C. and, unless otherwise specified, a wavelength of 550 nm. Re can be determined from the equation: Re=(nx−ny)×d, where d (nm) represents the thickness of the layer (film). Herein, the “phase difference” means the in-plane phase difference, unless otherwise specified.

The thickness direction phase difference (Rth) means the thickness direction phase difference of a layer (film) at 23° C. and, unless otherwise specified, a wavelength of 550 nm. Rth can be determined from the equation: Rth={(nx+ny)/2−nz}×d, where d (nm) represents the thickness of the layer (film).

Herein, the thickness direction phase difference is also referred to as “thickness phase difference”.

The “nx” is a refractive index in the direction in which the in-plane refractive index is maximum (i.e., slow axis direction). The “ny” is a refractive index in the direction perpendicular to the slow axis in the plane. The “nz” is a refractive index in the thickness direction. A refractive index means, unless otherwise specified, a value for light with a wavelength of 550 nm at 23° C.

The first polarizing plate 41 may or may not include a phase difference film. When the first polarizing plate 41 includes no phase difference film, the first adhesive layer 51 preferably has a storage modulus G″ of 40 KPa or lower at 85° C. or higher and 95° C. or lower. The expression that the first polarizing plate 41 includes no phase difference film means not only that the first polarizing plate 41 does not include any phase difference film as its component but also that no phase difference film is attached to the first polarizing plate 41 directly or indirectly via any other component, on a side of the first adhesive layer 51 opposite to the display cell 20. In other words, the expression means that when all the components on the side of the first adhesive layer 51 opposite to the display cell 20 are regarded as the components of the first polarizing plate 41, the first polarizing plate 41 does not include any phase difference film.

As shown in FIG. 2, a polarizing plate suitable as the polarizing plate 40 includes, for example, a protective layer 410 on at least one of the observation surface side or the back surface side of a polarizing layer (also referred to as polarizer) 420. As shown in FIG. 2, the polarizing plate 40 in the display panel 1 according to the present embodiment includes the protective layers 410 on the respective sides of the polarizing layer 420.

The polarizing layer 420 is not limited and may be a conventionally known one. Specific examples thereof include films obtained by adsorbing iodine or an anisotropic material such as a dichroic dye onto a hydrophilic polymer film, followed by uniaxial stretching, and polyene-based alignment films such as dehydrated polyvinyl alcohol films and dehydrochlorinated polyvinyl chloride films.

Non-limiting preferred examples of the protective layer 410 include protective films such as triacetyl cellulose (TAC) films. The protective layer 410 is attached to the polarizing layer 420 via any appropriate bonding layer (not shown).

A bonding layer bonds the surfaces of adjacent optical elements or layers together, integrating them with a practically sufficient bonding strength and bonding time. Examples of materials for forming the bonding layer include bonding agents and anchor coating agents. The bonding layer may have a multi-layer structure in which an anchor coating layer is formed on the surface of the adherend, and a bonding layer is formed thereon. It may also be a thin layer that is not visible to the naked eye.

A linearly polarizing plate is suitable as the polarizing plate 40. An absorptive polarizing plate is also suitable as the polarizing plate 40.

The first adhesive layer 51 and the second adhesive layer 52 may be collectively referred to as “adhesive layer 50”. The adhesive layer 50 is formed from an adhesive composition. Non-limiting suitable examples of the adhesive composition include resin compositions mainly containing a resin such as a (meth)acrylic resin, a rubber resin, a urethane resin, an ester resin, a silicone resin, or a polyvinyl ether resin. In particular, an adhesive composition containing a (meth)acrylic resin as its base polymer is suitable from the viewpoints of transparency, weather resistance, heat resistance, and storage modulus. The adhesive composition may be active energy ray-curable or thermosetting.

The (meth)acrylic resin as a base polymer is preferably a polymer or copolymer having one or more (meth)acrylic acid esters as monomers. A suitable (meth)acrylic acid ester is a (meth)acrylic acid alkyl ester with an alkyl group having 1 to 20 carbon atoms. The alkyl group preferably has 1 to 8 carbon atoms. Specific suitable examples include butyl (meth)acrylate, ethyl (meth)acrylate, isooctyl (meth)acrylate, and 2-ethylhexyl (meth)acrylate.

The base polymer may be copolymerized with a polar monomer. The polar monomer is a monomer having a polar group such as a carboxyl group, a hydroxy group, an amide group, an amino group, and/or an epoxy group. Specific suitable examples include (meth)acrylic acid, 2-hydroxypropyl (meth)acrylate, hydroxyethyl (meth)acrylate, (meth)acrylamide, N,N-dimethylaminoethyl (meth)acrylate, and glycidyl (meth)acrylate.

The adhesive composition may contain only the base polymer, but may also further contain a cross-linking agent. Non-limiting examples of the crosslinking agent include divalent or higher metal ions capable of forming a carboxylate metal salt with a carboxyl group; polyamine compounds capable of forming an amide bond with a carboxyl group; polyepoxy compounds or polyols capable of forming an ester bond with a carboxyl group; and polyisocyanate compounds capable of forming an amide bond with a carboxyl group. Suitable among these are polyisocyanate compounds.

The adhesive composition may also contain one or two or more of various additives. Non-limiting examples of the additives include glass fibers, glass beads, resin beads, fillers, pigments, colorants, antioxidants, ultraviolet absorbers, and antistatic agents.

The adhesive layer 50 has a thickness (thickness of the dry film) of preferably, for example, 100 μm or less, more preferably 60 μm or less, still more preferably 50 μm or less, particularly preferably 30 μm or less, most preferably 20 μm or less. The lower limit thereof is preferably 1 μm or more, more preferably 2 μm or more, still more preferably 3 μm or more, particularly preferably 5 μm or more, most preferably 10 μm or more.

The storage modulus of the adhesive layer 50 is adjusted by a method that is different depending on the type of adhesive layer 50. For example, the storage modulus of an adhesive layer 50 made of a thermosetting resin can be adjusted by changing conditions including the heating temperature, heating time, and amount of curing agent. The storage modulus of an adhesive layer 50 made of a UV (ultraviolet ray) curable resin can be adjusted by changing conditions including the amount of UV irradiation and UV irradiation time. The adhesive layer 50 according to the present embodiment is made of a thermosetting resin.

The display panel 1 according to the present embodiment can be obtained by, for example, bonding a first polarizing plate laminate including the first polarizing plate 41 and the first adhesive layer 51 and a second polarizing plate laminate including the second polarizing plate 42 and the second adhesive layer 52 to the display cell 20. The first polarizing plate laminate and the second polarizing plate laminate may be collectively referred to as “polarizing plate laminate”.

The polarizing plate laminate can be produced, for example, by bonding individual layers together. Specifically, the polarizing plate laminate can be obtained by obtaining an adhesive sheet, followed by bonding it to the polarizing plate 40, for example. The adhesive sheet can be obtained, for example, by applying in a sheet shape an adhesive liquid, prepared by dissolving or dispersing an adhesive composition in an organic solvent, to the release surface of a release sheet, and then bonding another release sheet to the formed adhesive layer. The thus-obtained adhesive sheet has a structure in which the adhesive layer is sandwiched between the two release sheets. One of the release sheets is removed from the adhesive sheet and the exposed surface is bonded to the polarizing plate 40, so that a polarizing plate laminate can be obtained. To obtain the display panel 1, the other release sheet is removed from the adhesive sheet and the exposed surface is bonded to the display cell 20. The method for producing the display panel 1 is not limited to this production method.

The adhesive liquid can be applied by any method, including, for example, common application methods such as bar coating, knife coating, roll coating, blade coating, die coating, or gravure coating. The application may be performed using an appropriate coater such as a die coater, a comma coater, a reverse roll coater, a gravure coater, a rod coater, a wire bar coater, a doctor blade coater, or an air doctor coater. When the first adhesive layer 51 and the second adhesive layer 52 are to be separately formed using two types of adhesive compositions having different storage moduli, the compositions can be applied separately, for example, by switching coaters for each region to be coated.

Next, a detailed description is given of the storage modulus G′ of an adhesive layer (the adhesive layer 52 in the present embodiment) at 85° C. or higher and 95° C. or lower, the layer disposed adjacent to a polarizing plate (the second polarizing plate 42 in the present embodiment) including no phase difference film.

The second adhesive layer 52 has a storage modulus G′ of 40 KPa or lower at 85° C. or higher and 95° C. or lower. The second adhesive layer 52 has a storage modulus G′ of preferably 35 KPa or lower, more preferably 30 KPa or lower, at 85° C. or higher and 95° C. or lower. This mode can further reduce or prevent warping of the display panel 1 in high temperature environments.

The second adhesive layer 52 has a storage modulus G′ of preferably 5 KPa or higher, more preferably 10 KPa or higher, still more preferably 15 KPa or higher, at 85° C. or higher and 95° C. or lower. This mode can increase the bonding between the display cell 20 and the second polarizing plate 42.

The second adhesive layer 52 has a storage modulus G′ of preferably 5 KPa or higher and 40 KPa or lower, more preferably 10 KPa or higher and 35 KPa or lower, still more preferably 15 KPa or higher and 30 KPa or lower, at 85° C. or higher and 95° C. or lower. This mode can increase the bonding between the display cell 20 and the second polarizing plate 42 while reducing or preventing warping of the display panel 1 in high temperature environments.

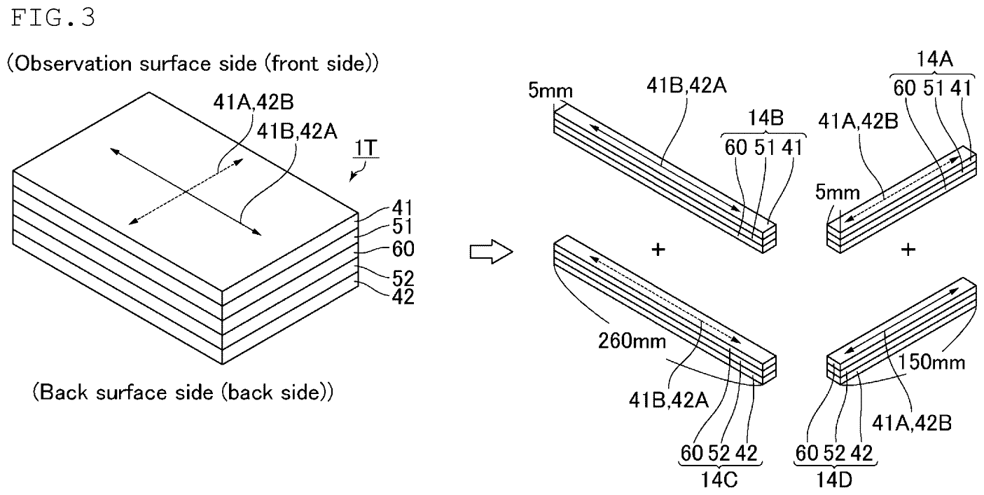

The storage modulus G′ of the second adhesive layer 52 leading to reduced warping of the display panel 1 in high temperature environments can be determined as follows. FIG. 3 is a schematic perspective view of a test panel corresponding to the display panel according to the embodiment. As shown in FIG. 3, a test panel 1T (hereinbelow, also referred to as simply “panel 1T”) includes the first polarizing plate 41, the first adhesive layer 51, a glass plate 60, the second adhesive layer 52, and the second polarizing plate 42. Since the display cell 20 has a structure in which a display medium layer is sandwiched between a pair of glass plates, the glass plate 60 can be regarded as the display cell 20. Thus, to examine the amount of warping of the display panel 1, the following examines the amount of warping Σ(G′) (mm) of the panel 1T which includes the glass plate 60 substituted for the display cell 20 in the display panel 1.

Specifically, as shown in FIG. 3, when the first polarizing plate 41 is disposed on the observation surface side of the glass plate 60 (corresponding to the display cell 20) via the first adhesive layer 51 and the second polarizing plate 42 including no phase difference film is disposed on the back surface side of the glass plate 60 via the second adhesive layer 52, the actual amount of warping Σ(G′) of the panel after high-temperature aging can be determined from the following Equation (1) using the storage modulus G′ of the second adhesive layer 52. The amount of warping of the panel due to the high-temperature aging can be limited within the desired range by setting the storage modulus G′ of the second adhesive layer 52 using Equation (1) such that the amount of warping Σ(G′) of the panel satisfies the desired value.

$$( Equation 1 )$$

$$\sum ( {G}^{′} ) = σ ( {G}^{′} ) - ( - 5.0000 \times 1 {0}^{- 4} \times {G}^{′2} + 2.93 \times 1 {0}^{- 2} \times {G}^{′} + 0.7794 )$$

In Equation (1), σ(G′) is represented by the following Equation (2).

$$σ ( {G}^{′} ) = C 1 \times 1.8315 \times 1 {0}^{- 3} \times {G}^{′} + 0.26666 \qquad ( Equation 2 )$$

In Equation (2), C1 is represented by the following Equation (3).

$$C 1 = \frac{3 {L}^{2} {E}_{1} {E}_{2} {t}_{1} {t}_{2} \times ( {t}_{1} + {t}_{2} ) \times ( {α}_{1} - {α}_{2} ) \times Δ T}{{E}_{1}^{2} {t}_{1}^{4} + 4 {E}_{1} {E}_{2} {t}_{1}^{3} {t}_{2} + 6 {E}_{1} {E}_{2} {t}_{1}^{2} {t}_{2}^{2} + 4 {E}_{1} {E}_{2} {t}_{1} {t}_{2}^{3} + {E}_{2}^{2} {t}_{2}^{4}} \qquad ( Equation 3 )$$

In Equation (3),
L represents the length (mm) of the half of the absorption axis of the second polarizing plate,
E₁ represents the Young's modulus (GPa) of the second polarizing plate,
E₂ represents the Young's modulus (GPa) of the glass plate,
t₁ represents the thickness (mm) of the second polarizing plate,
t₂ represents the thickness (mm) of the glass plate,
α₁ represents the coefficient of linear expansion (10⁻⁶/° C.) of the second polarizing plate,
α₂ represents the coefficient of linear expansion (10⁻⁶/° C.) of the glass plate, and
ΔT represents the temperature difference (° C.) of the panel between before and after the aging.

Since the glass plate 60 can be regarded as the display cell 20 as described above, in Equation (3), E₂ represents the Young's modulus (GPa) of the display cell, t₂ represents the thickness (mm) of the display cell, and α₂ represents the coefficient of linear expansion (10⁻⁶/° C.) of the display cell. The Young's modulus and coefficient of linear expansion of the display cell are respectively the Young's modulus and coefficient of linear expansion of the glass plates in the display cell. The thickness of the display cell is the sum of the thicknesses of the two glass plates in the display cell.

The temperature difference ΔT (° C.) of the panel between before and after the aging is preferably 25° C. or higher and 85° C. or lower, more preferably 25° C. or higher and 75° C. or lower, still more preferably 25° C. or higher and 65° C. or lower.

The temperature TP1 of the panel before the aging is preferably 15° C. or higher and 35° C. or lower, more preferably 15° C. or higher and 30° C. or lower, still more preferably 15° C. or higher and 25° C. or lower. The temperature TP2 after the aging is preferably 60° C. or higher and 100° C. or lower, more preferably 60° C. or higher and 90° C. or lower, still more preferably 60° C. or higher and 80° C. or lower. The temperature difference ΔT is represented by TP2−TP1.

The amount of warping Σ(G′) of the panel is preferably 0 mm or more and 0.30 mm or less. In other words, the second adhesive layer preferably has a storage modulus G′ that satisfies the following Inequality (1-1) at 85° C. or higher and 95° C. or lower. This mode can effectively reduce or prevent warping of the panel in high temperature environments.

$$- 0.3 \; 0 \leq σ ( {G}^{′} ) - ( - 5. 0000 \times 1 {0}^{- 4} \times {G}^{′2} + 2.9300 \times 1 {0}^{- 2} \times {G}^{′} + 0.7794 ) \leq 0.3 \qquad ( Inequality 1 - 1 )$$

In Inequality (1-1), σ(G′) is represented by Equation (2) above.

The amount of warping Σ(G′) of the panel is preferably 0 mm or more and 0.25 mm or less. In other words, the second adhesive layer more preferably has a storage modulus G′ that satisfies the following Inequality (1-2) at 85° C. or higher and 95° C. or lower. This mode can more effectively reduce or prevent warping of the panel in high temperature environments.

$$- 0.25 \leq σ ( {G}^{′} ) - ( - 5. 0000 \times 1 {0}^{- 4} \times {G}^{′2} + 2.9300 \times 1 {0}^{- 2} \times {G}^{′} + 0.7794 ) \leq 0.25 \qquad ( Inequality 1 - 2 )$$

In Inequality (1-2), σ(G′) is represented by Equation (2) above.

The display panel 1 has, for example, one side with a length of preferably 90 mm or more and 300 mm or less, more preferably 90 mm or more and 250 mm or less, still more preferably 90 mm or more and 200 mm or less. This mode can effectively reduce or prevent warping of the display panel 1 in high temperature environments.

The display cell 20 has a structure in which a layer of a display medium capable of providing display through optical modulation, such as a liquid crystal material, is sandwiched between a pair of substrates. Such a display cell 20 is generally produced by injecting a display medium into an empty cell, which is composed of a pair of substrates bonded together by a sealing material except for the injection port for the display medium, and then sealing the injection port with a sealing material.

The display cell 20 may be any display cell that has a function of displaying images. The display of images on the display cell 20 can be turned on or off. The display cell 20 is preferably a display cell for in-vehicle panels. This mode can effectively reduce the amount of warping of the panel in high temperature environments.

The display cell 20 is preferably, for example, a liquid crystal cell or a self-luminous cell. The display panel 1 including a liquid crystal cell as the display cell 20 serves as a liquid crystal display panel. Hereinbelow, a case of using a liquid crystal cell 21 as the display cell 20 is described as an example.

The liquid crystal cell 21 is a display cell including a liquid crystal layer. The liquid crystal cell 21 may have any structure such as, for example, a structure in which a liquid crystal layer 240 is sandwiched between a pair of glass plates 230 as shown in FIG. 2. Specific examples include a structure in which a liquid crystal layer is sandwiched between a pair of substrates, one of which includes pixel electrodes and a common electrode, and voltage is applied between the pixel electrodes and the common electrode to generate transverse electric fields (including fringe electric fields) in the liquid crystal layer, thus providing display; and a structure in which a liquid crystal layer is sandwiched between a pair of substrates, one of which includes pixel electrodes and the other of which includes a common electrode, and voltage is applied between the pixel electrodes and the common electrode to generate vertical electric fields in the liquid crystal layer, thus providing display.

Specific examples of the transverse electric field mode include the fringe field switching (FFS) mode and the in-plane switching (IPS) mode, in each of which the liquid crystal molecules in the liquid crystal layer are aligned parallel to the substrate surface during no voltage application. Examples of the vertical electric field mode include the vertical alignment (VA) mode in which the liquid crystal molecules in the liquid crystal layer are aligned vertically to the substrate surface during no voltage application.

The liquid crystal cell 21 may employ any liquid crystal mode, and may provide black display by aligning the liquid crystal molecules in the liquid crystal layer 240 vertically or parallel to the substrate surface or in a direction neither parallel nor vertical to the substrate surface. The liquid crystal panel may be driven by the TFT system (active matrix system), the simple matrix system (passive matrix system), or the plasma address system, for example.

The display panel 1 according to the present embodiment may be produced by any method such as, for example, bonding polarizing plate laminates to the display cell 20. The polarizing plate laminates are each bonded such that the adhesive layer 50 of the polarizing plate laminate comes into contact with the display cell 20.

The display panel 1 according to the present embodiment may also include a light source component. When the liquid crystal cell 21 is used as the display cell 20, the display panel 1 is preferably equipped with a backlight.

The light source component may be any light source unit that emits light, and may be a direct-lit one, an edge-lit one, or one of any other type. Specifically, the light source component preferably includes a light source unit with a light guide plate and light sources, a reflective sheet, and a diffusion sheet. The light sources can be, for example, light emitting diodes (LEDs).

The display panel 1 according to the present embodiment may include a cover glass plate on its surface closest to the observation surface side. While conventional display panels sometimes cause display unevenness due to the cover glass plate or the like component pressing the warped display panel, the display panel 1 according to the present embodiment, which is sufficiently less warped even in high temperature environments, can reduce or prevent occurrence of such display unevenness.

### Modified Example of Embodiment

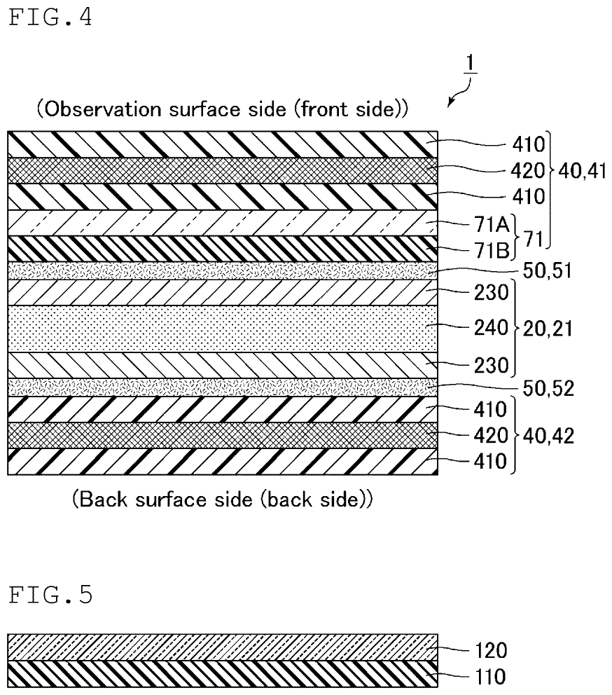

FIG. 4 is an enlarged schematic cross-sectional view of a display panel according to a modified example of the embodiment. As shown in FIG. 4, the first polarizing plate 41 may include a phase difference film 71.

When the first polarizing plate 41 includes a phase difference film, the first adhesive layer 51 has a storage modulus G″ of preferably 80 KPa or higher, more preferably 85 KPa or higher, still more preferably 90 KPa or higher, at 85° C. or higher and 95° C. or lower. This mode can increase the bonding between the display cell 20 and the first polarizing plate 41.

When the first polarizing plate 41 includes a phase difference film, the first adhesive layer 51 has a storage modulus G″ of, for example, 150 KPa or lower at 85° C. or higher and 95° C. or lower.

The expression that the first polarizing plate 41 includes a phase difference film 71 means not only that the first polarizing plate 41 includes the phase difference film 71 as its component but also that the phase difference film 71 is attached to the first polarizing plate 41 directly or indirectly via any other component, on the side of the first adhesive layer 51 opposite to the display cell 20. In other words, the expression means that when all the components on the side of the first adhesive layer 51 opposite to the display cell 20 are regarded as the components of the first polarizing plate 41, the first polarizing plate 41 includes the phase difference film 71. For example, the expression means that the phase difference film 71 is present between the first adhesive layer 51 and a polarizing layer 420, which is described later, in the first polarizing plate 41. The phase difference film 71 includes at least one phase difference layer. The phase difference film 71 may be a laminate of multiple phase difference layers. The phase difference film 71 is, for example, a laminate including, in order from the polarizing layer 420 toward the first adhesive layer 51, a first phase difference layer 71A and a second phase difference layer 71B.

The phase difference film 71 is preferably, for example, a laminate including a negative B plate as the first phase difference layer 71A and a positive B plate as the second phase difference layer 71B. The negative B plate exhibits refractive index anisotropy, with the relationship nx>ny>nz holding. The positive B plate exhibits refractive index anisotropy, with the relationship nz>nx>ny holding.

The phase difference film 71 is also preferably a laminate of a positive A plate as the first phase difference layer 71A and a positive C plate as the second phase difference layer 71B. The positive A plate exhibits refractive index anisotropy, with the relationship nx>ny=nz holding. The positive C plate exhibits refractive index anisotropy, with the relationship nz>nx=ny holding.

The phase difference film 71 may also be a laminate of a biaxially oriented first phase difference layer 71A and a biaxially oriented second phase difference layer 71B.

When the phase difference film 71 includes multiple phase difference layers, each phase difference layer preferably has an in-plane phase difference or an absolute value of a thickness direction phase difference of 10 nm or more.

An embodiment of the present invention has been described hereinabove. Each and every matter described above is applicable to the general aspects of the present invention.

### Examples

The present invention is described in more detail below based on an example. The present invention is not limited to the example. In the following example, unless otherwise specified, the display cell 20 was the liquid crystal cell 21 having a rectangular planar shape and a structure including a liquid crystal layer sandwiched between a pair of glass plates (substrates), and the first polarizing plate 41 and the second polarizing plate 42 were absorptive linearly polarizing plates.

### Example

In the present example, calculations were performed by the following procedure so that the amount of warping of the panel in high temperature environments can be determined regardless of the structure of the display panel and the aging conditions. The storage modulus G′ herein refers to the storage modulus of the second adhesive layer, unless otherwise specified.

### <Step 1>

With reference to a bimetal model, the amount of warping is calculated for the case where the second polarizing plate 42 (polarizing plate including no phase difference film) and the glass plate 60 are bonded. In the present example, an alkali-free glass plate having an alkali oxide content of 0.10% or less was used as the glass plate 60.

### <Step 2>

The amount of warping of a strip-sized panel portion (having a structure of “glass plate+adhesive layer+polarizing plate”) relative to the storage modulus G′ is calculated using the result from Step 1 and the measured data on the amount of warping of the strip-sized panel portion. The amount of warping is that in the direction of the absorption axis (second absorption axis 42B in the present example) of the polarizing plate including no phase difference film.

### <Step 3>

The amount of warping of a standard-sized panel (having a structure of “front polarizing plate+front adhesive layer+glass plate+back adhesive layer+back polarizing plate) relative to the storage modulus G′ is calculated using the result from Step 2 and the measured data on the amount of warping of the standard-sized panel.

### <Supplement to Step 1>

An in-vehicle panel basically has a structure in which a polarizing plate is attached to each side of a glass plate. The polarizing plates and the glass plate have different heat shrinkage rates, which presumably means that the concept of bimetal can be employed. FIG. 5 is a schematic cross-sectional view of a bimetal. The basic bimetal model shown in FIG. 5 has a structure in which a first substance 110 and a second substance 120 having different heat shrinkage rates are completely bonded to each other. The amount of warping 5 of the basic bimetal model is represented by the following Equation (M).

$$δ = \frac{3 {L}^{2} {E}_{1} {E}_{2} {t}_{1} {t}_{2} ( {t}_{1} + {t}_{2} ) ( {α}_{1} - {α}_{2} ) Δ T}{{E}_{1}^{2} {t}_{1}^{4} + 4 {E}_{1} {E}_{2} {t}_{1}^{3} {t}_{2} + 6 {E}_{1} {E}_{2} {t}_{1}^{2} {t}_{2}^{2} + 4 {E}_{1} {E}_{2} {t}_{1} {t}_{2}^{3} + {E}_{2}^{2} {t}_{2}^{4}} \qquad ( Equation M )$$

In Equation (M),
L represents the length (mm) of the sample (basic bimetal model),
E₁ represents the Young's modulus (GPa) of the first substance,
E₂ represents the Young's modulus (GPa) of the second substance,
t₁ represents the thickness (mm) of the first substance,
t₂ represents the thickness (mm) of the second substance,
α₁ represents the coefficient of linear expansion (10⁻⁶/° C.) of the first substance,
α₂ represents the coefficient of linear expansion (10⁻⁶/° C.) of the second substance, and
ΔT represents the temperature difference (° C.) of the sample between before and after the aging.

Delta “δ” on the left side of the above Equation (M), which is normally expressed as the amount of deflection, is expressed as the amount of warping here. The parameters on the right side of the above Equation (M) are the sample length (L), Young's moduli (E₁, E₂), thicknesses (t₁, t₂), coefficients of linear expansion (α₁, α₂), and temperature difference (ΔT).

The present inventors found from their extensive investigations that it is useful to examine the amount of warping after high-temperature aging separately on the four strip-sized panel portions (first panel portion 14A, second panel portion 14B, third panel portion 14C, and fourth panel portion 14D) shown in FIG. 3. The first panel portion 14A is a laminate of the first polarizing plate 41, the first adhesive layer 51, and the glass plate 60 and has a strip-like shape with its long axis lying in the first transmission axis 41A direction (in FIG. 3, the short axis direction of the panel 1T) and its short axis (for example, width 5 mm) lying in the first absorption axis 41B direction. The second panel portion 14B is a laminate of the first polarizing plate 41, the first adhesive layer 51, and the glass plate 60 and has a strip-like shape with its long axis lying in the first absorption axis 41B direction (in FIG. 3, the long axis direction of the panel 1T) and its short axis (for example, width 5 mm) lying in the first transmission axis 41A direction. The third panel portion 14C is a laminate of the second polarizing plate 42, the second adhesive layer 52, and the glass plate 60 and has a strip-like shape with its long axis lying in the second transmission axis 42A direction (in FIG. 3, the long axis direction of the panel 1T) and its short axis (for example, width 5 mm) lying in the second absorption axis 42B direction. The fourth panel portion 14D is a laminate of the second polarizing plate 42, the second adhesive layer 52, and the glass plate 60 and has a strip-like shape with its long axis lying in the second absorption axis 42B direction (in FIG. 3, the short axis direction of the panel 1T) and its short axis (for example, width 5 mm) lying in the second transmission axis 42A direction.

The amounts of warping of the first panel portion 14A to the fourth panel portion 14D shown in FIG. 3 were determined from the calculation equation for a bimetal, which is represented as Equation (M). The actual in-vehicle panel includes, as shown in FIG. 3, the first polarizing plate 41 and the second polarizing plate 42 attached to the respective sides of the glass plate 60, with the first absorption axis 41B and the second absorption axis 42B set perpendicular to each other.

The examinations made by the present inventors revealed that the amount of warping of a panel has the following two features.

Feature A: A panel warps in the absorption axis direction of the polarizing plate with no phase difference film.

Feature B: The warping of a panel depends only on the storage modulus of the polarizing plate with no phase difference film.

Further details on the feature A are provided. A standard panel includes a phase difference film on either its front polarizing plate or back polarizing plate, and the panel warps in the absorption axis direction of the polarizing plate with no phase difference film. In the present embodiment, a polarizing plate (second polarizing plate 42) with no phase difference film is disposed on the back surface side (back side) of the display cell 20 (glass plate 60), and a polarizing plate (first polarizing plate 41) with a phase difference film is disposed on the observation surface side (front side) of the display cell 20 (glass plate 60).

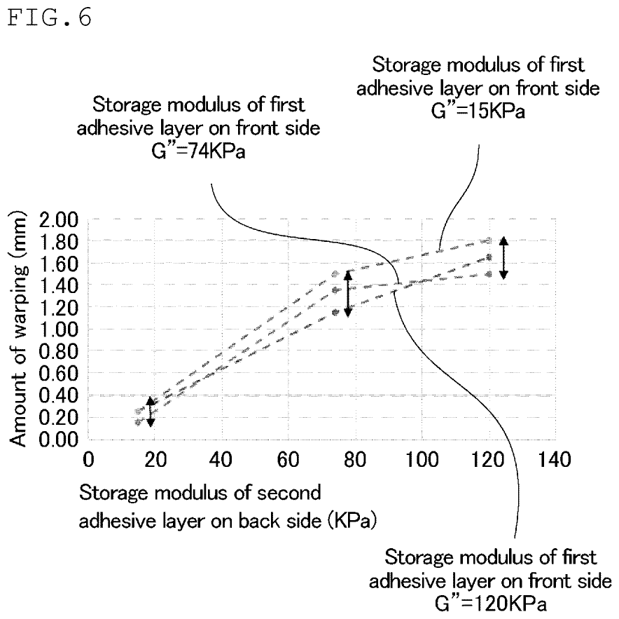

Further details on the feature B are provided. In an experiment in which the storage modulus G″ of the first adhesive layer 51 and the storage modulus G′ of the second adhesive layer 52 were varied in a standard-sized panel, the amount of warping of the panel changed when the storage modulus G′ of the second adhesive layer 52 disposed on the back side was changed while the storage modulus G″ of the first adhesive layer 51 disposed on the front side was fixed. On the contrary, the amount of warping of the panel hardly changed even when the storage modulus G″ of the first adhesive layer 51 disposed on the front side was changed while the storage modulus G′ of the second adhesive layer 52 disposed on the back side was fixed. FIG. 6 shows the results. FIG. 6 is a graph of the amount of warping of a panel versus storage modulus G′ of the second adhesive layer.

FIG. 6 shows the plots of the amount of warping of a panel relative to the storage modulus G′ of the second adhesive layer 52 for three patterns in which the storage modulus G″ of the first adhesive layer 51 was 120 KPa, 74 KPa, and 15 KPa.

The regions indicated by the double-headed arrows in FIG. 6 show that, for example, in the pattern in which the storage modulus G′ of the second adhesive layer 52 was 120 KPa, the change in amount of warping between when the storage modulus G″ of the first adhesive layer 51 was 15 KPa and when the storage modulus G″ was 74 KPa was only about 0.30 mm. This amount of change is clearly smaller than the amount of change when the storage modulus G′ of the second adhesive layer 52 was changed from 15 KPa to 74 KPa.

In consideration of the two features above, only the amount of warping in the absorption axis direction of the polarizing plate (second polarizing plate 42) with no phase difference film was calculated in determining the amount of warping using the strip-sized panel portions. In other words, in the present example, the amount of warping of only the fourth panel portion 14D, which is a portion from the glass plate 60 to the second polarizing plate 42 of the panel 1T cut out in a strip-like shape in the second absorption axis 42B direction, was calculated. The detailed results are described later.

### <Results of Step 1>

The second polarizing plate 42 and the glass plate 60 exhibited physical values as shown in the following Table 1.

The shape desired to be prevented from warping in high temperature environments is the 260 mm×150 mm glass plate 60 (TFT side thickness 0.15 mm, CF side thickness 0.15 mm, total thickness 0.30 mm), and the length of the absorption axis of the polarizing plate (second polarizing plate 42) with no phase difference film was 150 mm. In calculation of the amount of warping of a panel, the half of the actual length of the absorption axis is taken as L. In other words, L was 75 mm.

TABLE 1

| | Sample length | L | mm | 75 |
|---|---|---|---|---|
| Second polarizing plate | Thickness | t₁ | mm | 0.117 |
| (with no phase difference | Young's modulus | E₁ | GPa | 2.798 |
| film) | Coefficient of | α₁ | 10⁻⁶/° C. | 69.25 |
| | linear expansion | | | |
| Glass plate | Thickness | t₂ | mm | 0.3 |
| | Young's modulus | E₂ | GPa | 71.6 |
| | Coefficient of | α₂ | 10⁻⁶/° C. | 0.00 |
| | linear expansion | | | |

The coefficient of linear expansion of a polarizing plate changes in response to the characteristics of the polarizing plate and the aging environment (temperature, heating time), and is thus required to be measured each time. The measurement method will be described separately. In the present example, the aging conditions were set to 85° C. and 1 hour. The coefficient of linear expansion of the sample under such conditions is shown in Table 1 above.

First, in the strip-sized panel portion, the amount of warping C1 in the second absorption axis 42B direction was calculated using Equation (3) corresponding to Equation (M). The temperature before the aging was 25° C. and the temperature after the aging was 85° C., so that the ΔT in Equation (3) was 60° C. The calculation resulted in C1=4.4772. This value indicates the amount of warping when the second polarizing plate 42 and the glass plate 60 were completely bonded (with no adhesive layer in between) and immediately after the aging was completed (the panel portion was taken out of the aging environment).

### <Results of Step 2>

In Step 2, an equation for calculating the amount of warping of a strip-sized panel portion relative to the storage modulus G′ was created from the amount of warping C1 obtained in Step 1 and the measured data on the amount of warping of the strip-sized panel portion. In the present example, the strip-sized panel portion included an adhesive layer, and the amount of warping thereof was measured 1 hour after the aging was completed (the panel portion was taken out). Thus, the measured amount of warping was less than the amount of warping calculated from Equation (3). The equation for calculating the amount of warping of the strip-sized panel portion was thus derived to make the calculated amount approach the measured amount.

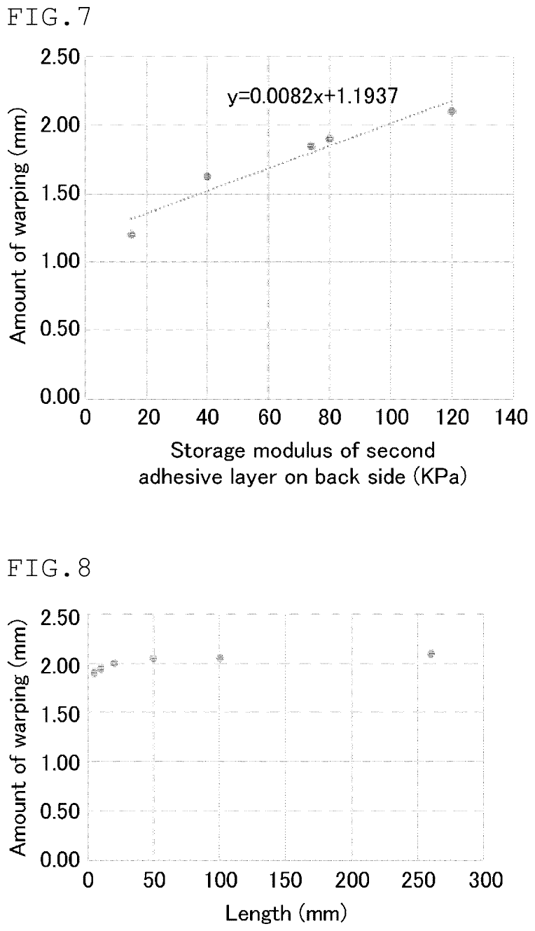

First, the measured data on the warping of the strip-sized portion (having a structure of “glass plate+adhesive layer+polarizing plate”) is shown in FIG. 7. FIG. 7 is a graph of the measured amount of warping of a strip-sized panel portion versus storage modulus G′ of the second adhesive layer. The measured strip-sized panel portion included an adhesive layer, and in the present example, the amount of warping thereof was measured 1 hour after the panel portion was taken out. In the case where an adhesive layer is present, the warping of the polarizing plate is transmitted to a lesser degree to the glass than in the case where the adhesive layer is absent (i.e., the calculated amount C1), so that the amount of warping of the strip-sized portion is small. Similarly, the smaller the storage modulus of the adhesive layer, the lesser the degree of transmission of the warping of the polarizing plate to the glass, and thus the smaller the warping of the strip-sized portion. Also, leaving the workpiece for a certain period of time after heating is found to result in less warping.

As shown in FIG. 7, the measured data on the warping of the strip-sized portion changed substantially linearly in response to the storage modulus of the adhesive layer. When the storage modulus is denoted as G′ and the actual amount of warping of the strip-sized portion in consideration of the presence of the adhesive layer and the leaving after heating is denoted as σ(G′), the following Equation (A) is derived.

$$σ ( {G}^{′} ) = ( 8.2000 \times 1 {0}^{- 3} \times {G}^{′} + 1.1937 ) \qquad ( Equation A )$$

When the equation for converting the calculated amount C1 to the actual amount of warping σ(G′) of the strip-sized portion is denoted as f(G′), the following Equation (B) is derived.

$$f ( {G}^{′} ) = \frac{σ ( {G}^{′} )}{C 1} = ( 1.8315 \times 1 {0}^{- 3} \times {G}^{′} + 0.26666 ) \qquad ( Equation B )$$

The actual amount of warping σ(G′) of the strip-sized portion is represented by the following Equation (B-1) using the conversion function f(G′).

$$σ ( {G}^{′} ) = ( C 1 \times f ( {G}^{′} ) ) \qquad ( Equation B - 1 )$$

In Equation (B-1), the relationship G′>0 holds.

The measured data in FIG. 7 indicates the amount of warping of a strip-sized portion having a length of 150 mm and a width of 5 mm. The amount of warping hardly changed when the width was increased to greater than 5 mm (data in FIG. 8). FIG. 8 is a graph of the measured amount of warping of a strip-sized panel portion. FIG. 8 shows the measured amount of warping of a rectangular panel portion having two sets of sides, one of the two sets being fixed to a length of 150 mm, relative to the length of the other set of sides. FIG. 8 shows that even when the structure of “glass plate+adhesive layer+polarizing plate” is embodied in a standard panel size (260 mm×150 mm), the amount of warping of the panel can be determined from the above Equation (A).

### <Results of Step 3>

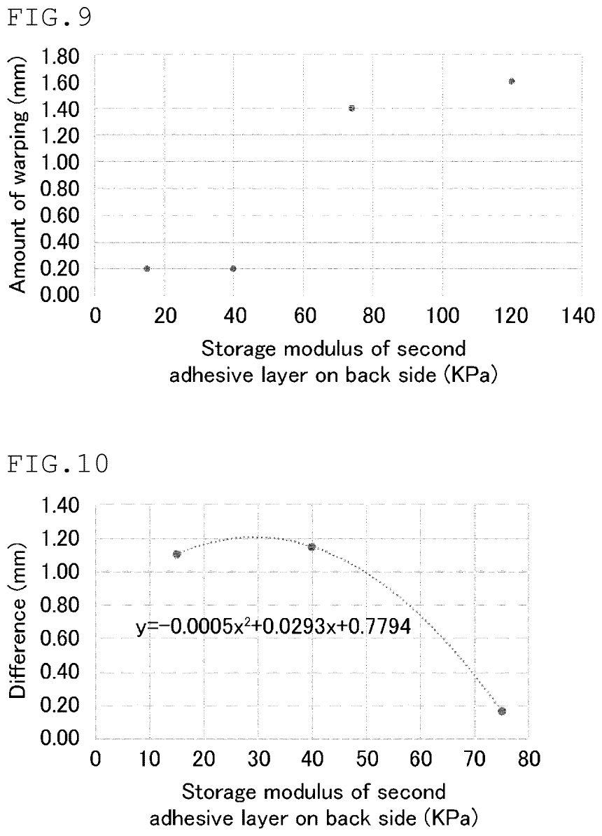

In Step 3, an equation for calculating the amount of warping of a standard-sized panel relative to the storage modulus G′ was created from the result from Step 2 and the measured data shown in FIG. 6 and FIG. 9. FIG. 9 is a graph of the average amount of warping of a standard-sized panel versus storage modulus G′ of the second adhesive layer disposed on the back side. FIG. 9 shows the measured data on the amount of warping of a standard panel (the average of the differences in storage modulus of the front adhesive layer).

The amount of warping Σ(G′) of the standard panel is less than the amount of warping σ(G′) because part of the amount of warping σ(G′) of the structure of “glass plate+back adhesive layer+back polarizing plate” is offset by the added structure of “front polarizing plate+front adhesive layer”. FIG. 9 shows that the amount of reduction in warping (difference from σ(G′)) varies depending on the storage modulus G′ of the back adhesive layer.

Since the present example aims to keep the amount of warping Σ(G′) of a standard panel to 0.30 mm or less, an equation expressing the amount of warping Σ(G′) was derived using three smaller measured storage moduli G′ of the back adhesive layer among the four measured data values.

FIG. 10 is a graph of differences between the measured data on the amount of warping of standard panel and σ(G′). The difference approximation function D(G′) shown in FIG. 10 is represented by the following Equation (C).

$$( Equation C )$$

$$D ( {G}^{′} ) = ( - 5.0000 \times 1 {0}^{- 4} \times {G}^{′2} + 2.93 \times 1 {0}^{- 2} \times {G}^{′} + 0.7794 )$$

Thus, the amount of warping Σ(G′) of the standard panel is represented by the following Equation (C-1).

$$\sum ( {G}^{′} ) = σ ( {G}^{′} ) - D ( {G}^{′} ) = σ ( {G}^{′} ) - ( - 5.0000 \times 1 {0}^{- 4} \times {G}^{′2} + 2.93 \times 1 {0}^{- 2} \times {G}^{′} + 0.7794 ) \qquad ( Equation C - 1 )$$

In Equation (C-1), the relationship G′>0 holds.

The amount of warping can be appropriately set, and is preferably, for example, within 0.30 mm. Equation (C-1) (i.e., Equation (1)) shows that to keep the amount of warping within 0.30 mm, for example, the storage modulus G′ of the second adhesive layer 52 should be set to 40 KPa or lower.

The coefficient of linear expansion can be calculated as follows.

Step 1: A polarizing plate is cut into a size of 90 mm×5 mm and the initial dimensions thereof are measured.

Step 2: The workpiece is put in a thermostatic chamber under the predetermined aging conditions.

Step 3: The workpiece put in the chamber is cooled for 1 hour, and then the dimensions of the workpiece after the aging are measured.

Step 4: The values obtained in Step 1 and Step 3 are substituted into the following Equation (N) to calculate the coefficient of linear expansion.

$$α = ( 1 / L ) \times ( dL / dT ) \qquad ( Equation N )$$

In Equation (N), α represents the coefficient of linear expansion, L represents the length of the object, dL represents the amount of change in the length of the object, T represents the temperature of the object, and dT represents the amount of change in the temperature of the object.

The embodiments of the present invention described above may appropriately be combined without departing from the gist of the present invention.

### REFERENCE SIGNS LIST

1: display panel
1T: panel (test panel)
14A, 14B, 14C, 14D: panel portion
20: display cell
21: liquid crystal cell
40, 41, 42: polarizing plate
41A, 42A: transmission axis
41B, 42B: absorption axis
50, 51, 52: adhesive layer
60, 230: glass plate
71: phase difference film
71A, 71B: phase difference layer
110, 120: substance
240: liquid crystal layer
410: protective layer
420: polarizing layer

What is claimed is:

1. A display panel comprising, in order:
a first polarizing plate with a first transmission axis;
a first adhesive layer;
a display cell;
a second adhesive layer; and
a second polarizing plate including no phase difference film and with a second transmission axis perpendicular to the first transmission axis,
the second adhesive layer having a storage modulus G′ of 40 KPa or lower at 85° C. or higher and 95° C. or lower.

2. The display panel according to claim 1,
wherein the second adhesive layer has a storage modulus G′ of 5 KPa or higher and 40 KPa or lower at 85° C. or higher and 95° C. or lower.

3. The display panel according to claim 1,
wherein the second adhesive layer after aging of the display panel with a temperature difference ΔT (° C.) has, at 85° C. or higher and 95° C. or lower, a storage modulus G′ that satisfies the following Inequality (1-1):
$$- 0.3 \leq σ ( {G}^{′} ) - ( - 5.0000 \times 1 {0}^{- 4} \times {G}^{′2} + 2.93 \times 1 {0}^{- 2} \times {G}^{′} + 0.7794 ) \leq 0.3 \qquad ( Inequality 1 - 1 )$$
where σ(G′) is represented by the following Equation (2):
$$σ ( {G}^{′} ) = C 1 \times 1.8315 \times 1 {0}^{- 3} \times {G}^{′} + 0.26666 \qquad ( Equation 2 )$$
where C1 is represented by the following Equation (3):
$$C 1 = \frac{3 {L}^{2} {E}_{1} {E}_{2} {t}_{1} {t}_{2} \times ( {t}_{1} + {t}_{2} ) \times ( {α}_{1} - {α}_{2} ) \times Δ T}{{E}_{1}^{2} {t}_{1}^{4} + 4 {E}_{1} {E}_{2} {t}_{1}^{3} {t}_{2} + 6 {E}_{1} {E}_{2} {t}_{1}^{2} {t}_{2}^{2} + 4 {E}_{1} {E}_{2} {t}_{1} {t}_{2}^{3} + {E}_{2}^{2} {t}_{2}^{4}} \qquad ( Equation 3 )$$
where
L represents a length (mm) that is a half of an absorption axis of the second polarizing plate,
E₁ represents a Young's modulus (GPa) of the second polarizing plate,
E₂ represents a Young's modulus (GPa) of the display cell,
t₁ represents a thickness (mm) of the second polarizing plate,
t₂ represents a thickness (mm) of the display cell,
α₁ represents a coefficient of linear expansion (10⁻⁶/° C.) of the second polarizing plate,
α₂ represents a coefficient of linear expansion (10⁻⁶/° C.) of the display cell, and
ΔT represents a temperature difference (° C.) of the display panel between before and after the aging.

4. The display panel according to claim 1,
wherein the first polarizing plate includes a phase difference film.

5. The display panel according to claim 4,
wherein the first adhesive layer has a storage modulus of 80 KPa or higher at 85° C. or higher and 95° C. or lower.

6. The display panel according to claim 1,
wherein the phase difference film has at least one of an in-plane phase difference or an absolute value of a thickness direction phase difference of 10 nm or more.
